(19) United States
(12) Patent Application Publication
(10) Pub. No.: US 2021/0076859 A1
(43) Pub. Date: Mar. 18, 2021

(54) Carpet Trim Tamping Assembly

(71) Applicant: Brant Borden, Noblesville, IN (US)

(72) Inventor: Brant Borden, Noblesville, IN (US)

(21) Appl. No.: 16/573,343

(22) Filed: Sep. 17, 2019

(51) Int. Cl. A47G 27/04; B25G 1/10

(52) U.S. Cl. CPC A47G 27/0487; B25D 1/00; A47G 27/045; B25G 1/10

(57) ABSTRACT

A carpet trim tamping assembly includes a block that has a pair of angled surfaces each oriented to form a 22.5 degree angle. Thus, each of the angled surfaces matches the angle between a top surface of a metal trim strip and adjacent carpet. A selected one of the angled surfaces is positionable upon the top surface of the metal trim strip and the block is struck to compress the metal trim strip against the adjacent carpet. In this way the appearance and finish of the metal trim strip is improved. A handle is coupled to the block and the handle has a bend thereon defining a first portion of the handle forming a 22.5 degree angle with a second portion of the handle. Thus, the handle can angle around a door jamb when the metal trim strip is positioned to extend along a threshold of a doorway.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to tamping devices and more particularly pertains to a new tamping device for compressing a metal trim strip onto adjacent carpet.

### BRIEF SUMMARY OF THE INVENTION

An embodiment of the disclosure meets the needs presented above by generally comprising a block that has a pair of angled surfaces each oriented to form a 22.5 degree angle. Thus, each of the angled surfaces matches the angle between a top surface of a metal trim strip and adjacent carpet. A selected one of the angled surfaces is positionable upon the top surface of the metal trim strip and the block is struck to compress the metal trim strip against the adjacent carpet. In this way the appearance and finish of the metal trim strip is improved. A handle is coupled to the block and the handle has a bend thereon defining a first portion of the handle forming a 22.5 degree angle with a second portion of the handle. Thus, the handle can angle around a door jamb when the metal trim strip is positioned to extend along a threshold of a doorway.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom perspective view of a carpet trim tamping assembly according to an embodiment of the disclosure.

FIG. 2 is a back view of an embodiment of the disclosure.

FIG. 3 is a bottom view of an embodiment of the disclosure.

FIG. 4 is a left side view of an embodiment of the disclosure.

FIG. 5 is a top view of an embodiment of the disclosure.

FIG. 6 is a perspective in-use view of an embodiment of the disclosure.

### DETAILED DESCRIPTION OF THE INVENTION

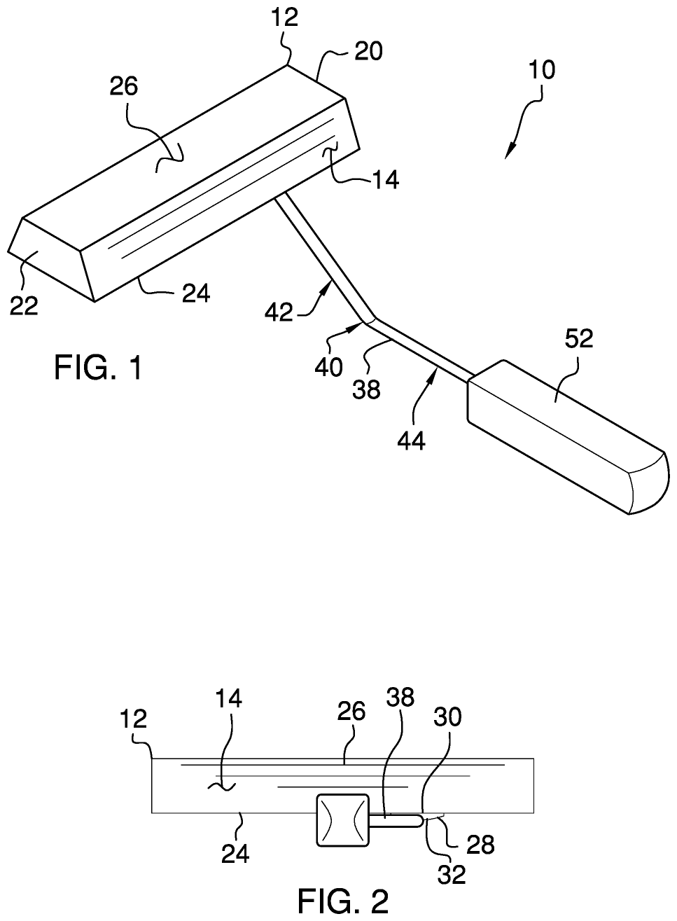

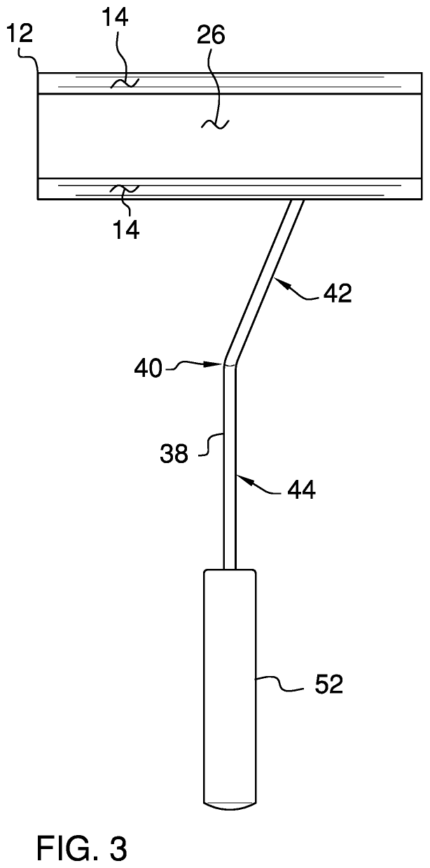

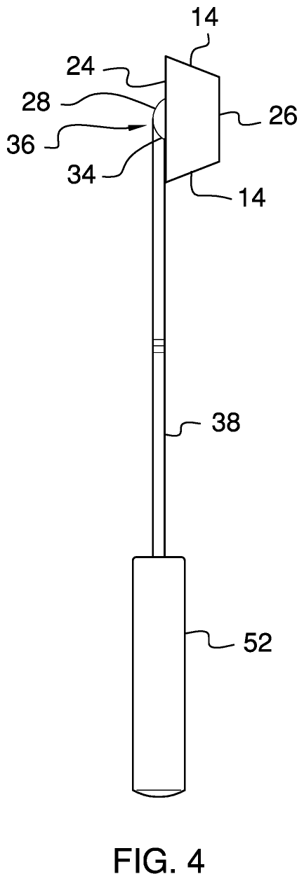

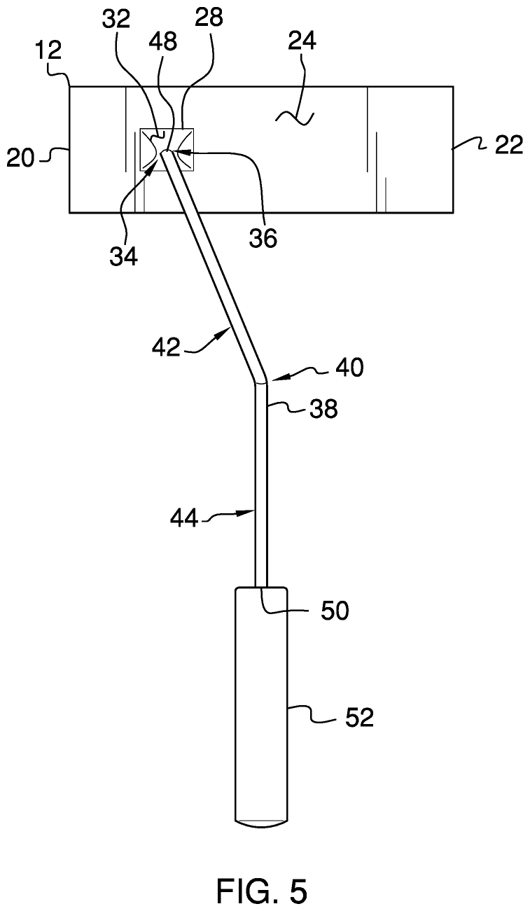

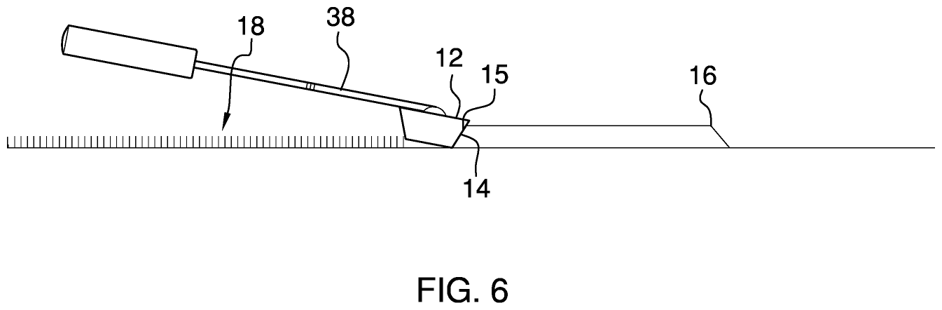

With reference now to the drawings, and in particular to FIGS. 1 through 6 thereof, a new tamping device embodying the principles and concepts of an embodiment of the disclosure and generally designated by the reference numeral 10 will be described.

As best illustrated in FIGS. 1 through 6, the carpet trim tamping assembly 10 generally comprises a block 12 that has a pair of angled surfaces 14, and each of the angled surfaces 14 is oriented to form a 22.5 degree angle with respect a vertical axis of the block 12. Thus, each of the angled surfaces 14 matches the angle between a top surface 15 of a metal trim strip 16 and adjacent carpet 18. The carpet 18 may be carpet of any conventional design that is laid on a floor and the metal trim strip 16 may be a door threshold or any other conventional metal trim commonly employed with carpet.

A selected one of the angled surfaces 14 is positionable upon the top surface 15 of the metal trim strip 16 having the selected angled surface 14 being oriented collinear with the metal trim strip 16. Moreover, the block 12 is struck with a hammer or the like when the block 12 is positioned on the metal trim strip 16. In this way the selected angled surface 14 compresses the metal trim strip 16 against the adjacent carpet 18 thereby improving the appearance and finish of the metal trim strip 16. Additionally, the block 12 evenly distributed the force of being struck across the entire top surface 15 of the metal trim strip 16 thereby inhibiting the metal trim strip 16 from being damaged when the metal trim strip 16 is seated against the carpet 18. The block 12 is comprised of a resiliently compressible material such as mechanics rubber or the like. In this way the block 12 resists scratching or otherwise damaging the top surface 15 of the metal trim strip 16.

The block 12 has a first end 20 and a second end 22, and the block 12 is elongated between the first 20 and second 22 ends. Each of the angled surfaces 14 extends between the first 20 and second 22 ends and the angled surfaces 14 are positioned on opposite sides of the block 12 with respect to each other. Moreover, each of the angled surfaces 14 slopes inwardly in opposite directions from each other at the 22.5 degree angle between a top surface 24 and a bottom surface 26 of the block 12. The top surface 24 of the block 12 may have a width of approximately 3.0 inches.

A coupler 28 is provided that has a first surface 30 and a second surface 32. The first surface 30 is flattened and the second surface 32 has a prominence 34 thereon. The prominence 34 slopes upwardly toward a peak 36 that is centrally located on the second surface 32. The first surface 30 is coupled to the top surface 24 of the block 12 and the coupler 28 is positioned closer to the first end 20 of the block 12 than the second end 22 of the block 12.

A handle 38 is coupled to the block 12 for gripping and the handle 38 has a bend 40 thereon defining a first portion 42 of the handle 38 forming a 45.0 degree angle with a second portion 44 of the handle 38. In this way the handle 38 can angle around a door jamb 46 or other obstacle when the metal trim strip 16 extends along a threshold of a doorway. The handle 38 has a coupled end 48 and a free end 50, and the coupled end 48 is coupled to the second surface 32 of the coupler 28. The coupled end 48 is positioned on the peak 36 of the prominence 34 thereby facilitating the first portion 42 of the handle 38 to be spaced from the top surface 24 of the block 12. The handle 38 extends along a line that is oriented parallel to the top surface 24 of the block 12. A grip 52 is coupled around the second portion 44 of the handle 38, and the grip 52 extends from the free end 50 toward the first portion 42 of the handle 38.

In use, the grip 52 is gripped and a selected one of the angled surfaces 14 is positioned on the top surface 15 of the metal trim strip 16. The top surface 24 of the block 12 is struck with a hammer or the like thereby facilitating the metal trim strip 16 to be compressed downwardly against adjacent carpet 18. In this way the metal trim strip 16 is seated into place thereby enhancing the visual appearance of the metal trim strip 16. The pair of angled surfaces 14 on the block 12 facilitate the block 12 to be flipped over to accommodate a right handed user or a left handed user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A carpet trim tamping assembly being configured to be struck against a metal trim strip on carpet to compress the metal trim strip against the carpet, said assembly comprising:
a block having a pair of angled surfaces, each of said angled surfaces being oriented to form a 22.5 degree angle with respect a vertical axis of said block wherein each of said angled surfaces is configured to match the angle between a top surface of a metal trim strip and adjacent carpet, a selected one of said angled surfaces being positionable upon the top surface of the metal trim strip having said selected angled surface being oriented collinear with the metal trim strip, said block being struck when said block is positioned on the metal trim strip wherein said selected angled surface is configured to compress the metal trim strip against the adjacent carpet thereby improving the appearance and finish of the metal trim strip; and
a handle being coupled to said block, said handle having a bend thereon defining a first portion of said handle forming a 22.5 degree angle with a second portion of said handle wherein said handle is configured to angle around a door jamb when the metal strip extends along a threshold of a doorway.

2. The assembly according to claim 1, wherein said block has a first end and a second end, said block being elongated between said first and second ends, each of said angled surfaces extending between said first and second ends, said angled surfaces being positioned on opposite sides of said block with respect to each other, each of said angled surfaces sloping inwardly in opposite directions from each other at said 22.5 degree angle between a top surface and a bottom surface of said block.

3. The assembly according to claim 2, further comprising a coupler having a first surface and a second surface, said first surface being flattened, said second surface having a prominence thereon, said prominence sloping upwardly toward a peak being centrally located on said second surface, said first surface being coupled to said top surface of said block, said coupler being positioned closer to said first end of said block than said second end of said block.

4. The assembly according to claim 3, wherein said handle has a coupled end and a free end, said coupled end being coupled to said second surface of said coupler, said coupled end being positioned on said peak of said prominence thereby facilitating said first portion of said handle to be spaced from said top surface of said block, said handle extending along a line being oriented parallel to said top surface of said block.

5. The assembly according to claim 1, further comprising a grip being coupled around said second portion of said handle wherein said grip is configured to be gripped, said grip extending from a free end of said handle toward said first portion of said handle.

6. A carpet trim tamping assembly being configured to be struck against a metal trim strip on carpet to compress the metal trim strip against the carpet, said assembly comprising:
a block having a pair of angled surfaces, each of said angled surfaces being oriented to form a 22.5 degree angle with respect a vertical axis of said block wherein each of said angled surfaces is configured to match the angle between a top surface of a metal trim strip and adjacent carpet, a selected one of said angled surfaces being positionable upon the top surface of the metal trim strip having said selected angled surface being oriented collinear with the metal trim strip, said block being struck when said block is positioned on the metal trim strip wherein said selected angled surface is configured to compress the metal trim strip against the adjacent carpet thereby improving the appearance and finish of the metal trim strip, said block having a first end and a second end, said block being elongated between said first and second ends, each of said angled surfaces extending between said first and second ends, said angled surfaces being positioned on opposite sides of said block with respect to each other, each of said angled surfaces sloping inwardly in opposite directions from each other at said 22.5 degree angle between a top surface and a bottom surface of said block; and
a coupler having a first surface and a second surface, said first surface being flattened, said second surface having a prominence thereon, said prominence sloping upwardly toward a peak being centrally located on said second surface, said first surface being coupled to said top surface of said block, said coupler being positioned closer to said first end of said block than said second end of said block;
a handle being coupled to said block, said handle having a bend thereon defining a first portion of said handle forming a 22.5 degree angle with a second portion of said handle wherein said handle is configured to angle around a door jamb when the metal strip extends along a threshold of a doorway, said handle having a coupled end and a free end, said coupled end being coupled to said second surface of said coupler, said coupled end being positioned on said peak of said prominence thereby facilitating said first portion of said handle to be spaced from said top surface of said block, said handle extending along a line being oriented parallel to said top surface of said block; and
a grip being coupled around said second portion of said handle wherein said grip is configured to be gripped, said grip extending from said free end toward said first portion of said handle.
